(19) United States
(12) Patent Application Publication
(10) Pub. No.: US 2009/0171895 A1
(43) Pub. Date: Jul. 2, 2009

(54) METHOD AND SYSTEM FOR GENERATING DYNAMIC ASSOCIATIONS TO DATA OBJECTS

(76) Inventor: HERBERT HACKMANN, Wiesloch (DE)

Correspondence Address: SAP AG, 3410 HILLVIEW AVENUE, PALO ALTO, CA, 94304, US

(21) Appl. No.: 11/965,797

(22) Filed: Dec. 28, 2007

(51) Int. Cl. G06F 7/10; G06F 17/30

(52) U.S. Cl. 707/3; 707/E17.014

(57) ABSTRACT

A method and system for generating dynamic associations to data objects is provided. A structure hierarchy is generated based on a first configuration data. The structure hierarchy has a folder node. A second configuration for a query is generated. The query is associated to the folder node in the structure hierarchy. The query is executed in a data object based on the configuration data. A data object instance is retrieved as a result of executing the query. The data object instance is associated to the structure hierarchy

### TECHNICAL FIELD

Embodiments of the invention generally relate to computer systems, and more particularly to a method and system for generating dynamic associations to data objects.

### BACKGROUND

In computer science, associations exist between data object instances. In current computing systems, the associations between data object instances of different data object types are declared at a modeling time or design time. Each data object instance generally includes a unique identifier for the data object instance often referred to as the key of the data object instance. The associations typically exist between the keys of the data object instances. The associations are usually stored in a data base table or an XML (Extensible Markup Language) file.

Queries are typically used to execute searches in the data object. In the current computing systems, the queries that are used to execute searches in the data objects must be declared during the modeling time or design time. A declaration of the query typically includes declaring one or more query names and query parameters in a service repository.

This persistent approach for data object associations and queries is not very useful for dynamic scenarios such as context related search and dynamic associations between data object instances.

### SUMMARY OF THE INVENTION

Embodiments of the invention are generally directed to a method and system for generating dynamic associations to data objects. A structure hierarchy is generated based on a first configuration data. The structure hierarchy has a folder node. A second configuration for a query is generated. The query is associated to the folder node in the structure hierarchy. The query is executed in a data object based on the configuration data. A data object instance is retrieved as a result of executing the query. The data object instance is associated to the structure hierarchy.

These and other benefits and features of embodiments of the invention will be apparent upon consideration of the following detailed description of preferred embodiments thereof, presented in connection with the following drawings in which like reference numerals are used to identify like elements throughout.

### BRIEF DESCRIPTION OF THE DRAWINGS

The claims set forth the embodiments of the invention with particularity. The embodiments of the invention, together with its advantages, may be best understood from the following detailed description taken in conjunction with the accompanying drawings. The invention is illustrated by way of example and not by way of limitation in the figures of the accompanying drawings. It should be noted that references to “an” or “one” embodiment in this disclosure are not necessarily to the same embodiment, and such references mean at least one.

FIG. 1 is a functional block diagram of a system for generating dynamic associations to data objects according to an embodiment of the invention.

FIG. 2 is a flow diagram of a process for generating dynamic associations to data objects according to an embodiment of the invention.

FIG. 3 is a flow diagram of a process for generating dynamic associations to data objects according to an embodiment of the invention.

FIG. 4 is a block diagram of a system for generating dynamic associations to data objects useful for implementing the invention according to an embodiment of the invention.

### DETAILED DESCRIPTION

Embodiments of the invention are generally directed to a method and system for generating dynamic associations to data objects. A structure hierarchy is generated based on a first configuration data. The structure hierarchy has a folder node. A second configuration for a query is generated. The query is associated to the folder node in the structure hierarchy. The query is executed in a data object based on the configuration data. A data object instance is retrieved as a result of executing the query. The data object instance is associated to the structure hierarchy.

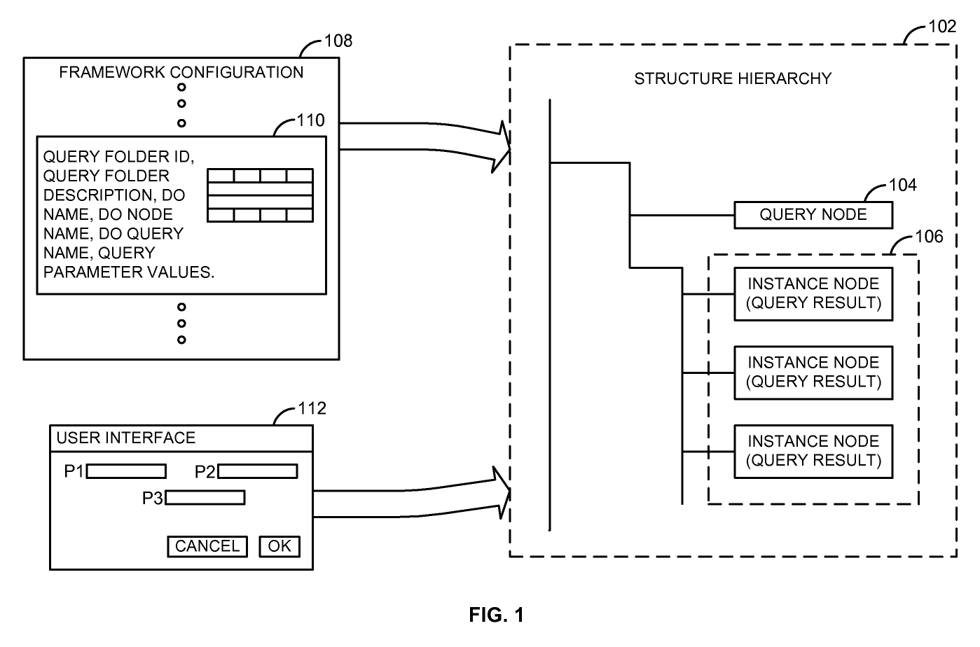

FIG. 1 is a functional block diagram of a system for generating dynamic associations to data objects according to an embodiment of the invention. Structure hierarchy 102 typically includes one or more folder nodes arranged in a hierarchical order. A folder node in structure hierarchy 102 may point to (or linked to) one or more data object instances, documents or a query. In an embodiment a folder node in structure hierarchy 102 may include business properties. Query node 104 in structure hierarchy 102 is a folder node of query type. Query node 104 may be used to execute a query in a data object. The instance nodes 106 are data object instances obtained as a result (query result) of executing the query. The query, the data object and one or more query parameters based on which the query is executed in the data object is defined as query definitions in framework configuration 108. In an embodiment, instance nodes 106 have a transient character with the data object instances being determined at runtime and the data object instance identifiers of the data object instances not being stored in structure hierarchy 102. The query definition for query node 104 typically includes a query folder identifier, a query folder description, a data object (DO) name, a data object node name, a data object query name, one or more query parameters. In an embodiment the query definition may be configured during a configuration time or a runtime. In an embodiment, a context of user interface 112 is bound to structure hierarchy and the query parameters used for executing the query on the business object are received from the context of user interface 112 during the runtime.

A user typically marks a folder node in structure hierarchy 102 for creating query node 104. The user is generally presented with a list of queries for which definitions exist in framework configuration 108. The user may typically select a query from the list of queries. On selecting the query from the list of queries, the query is inserted in the folder node as query node 104. In an embodiment, saving structure hierarchy 102 saves query node 104 along with a node position in structure hierarchy 102.

On selecting query node 104 in structure hierarchy 102, the query definitions for the query in framework configuration 108 are read and analyzed. The query, the data object and one or more query parameters to be used for searching the data object are determined from the query definitions. The query is executed in the data object based on the query definitions. Structure hierarchy 102 typically retrieves the query results as node identifiers. Each query result is typically a data object instance. The data object instances received as query results are associated with structure hierarchy as instance nodes 106 to query node 104. In an embodiment, instance nodes 106 are associated as child nodes to query node 104.

In an embodiment, on selecting one or the instance nodes 106 in structure hierarchy 102, an instance floor plan of the data object instance is retrieved and displayed to the user. In an embodiment instance nodes 106 are not saved on saving structure hierarchy 102.

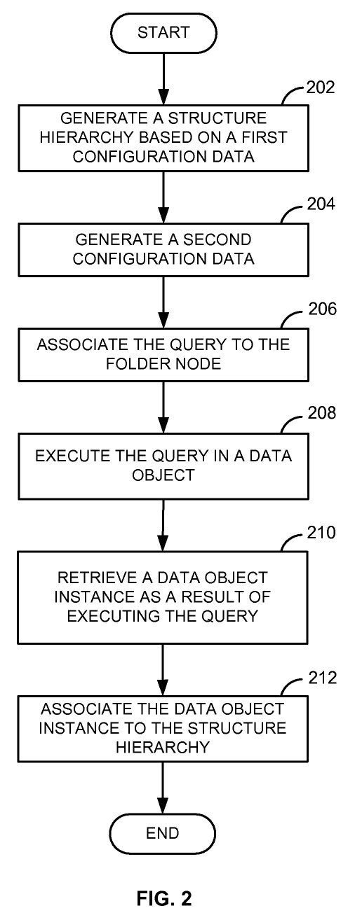

FIG. 2 is a flow diagram of a process for generating dynamic associations to data objects according to an embodiment of the invention. In process block 202, a structure hierarchy is generated based on a first configuration data with the structure hierarchy having a folder node. The structure hierarchy typically includes one or more folder nodes arranged in a hierarchical order. A folder node in the structure hierarchy may point to (or linked to) one or more data object instances, documents or a query. In an embodiment a folder node in the structure hierarchy may include one or more business properties. The first configuration data is typically a structure template defining a hierarchal order of the folder nodes in the structure hierarchy. In process block 204 a second configuration data is generated. The second configuration data typically includes a query definition of a query. The query definition typically includes definition of the query, a data object on which the query may be executed and one or more query parameters using which the query may be executed in the data object. In process block 206, the query is associated with the folder node. In process block 208, the query is executed on the data object based on the query parameters that are declared in the query definition. In process block 210, a data object instance is retrieved as a result of executing the query on the data object. In process block 212, the data object instance is associated to the structure hierarchy typically as a child node to the folder node.

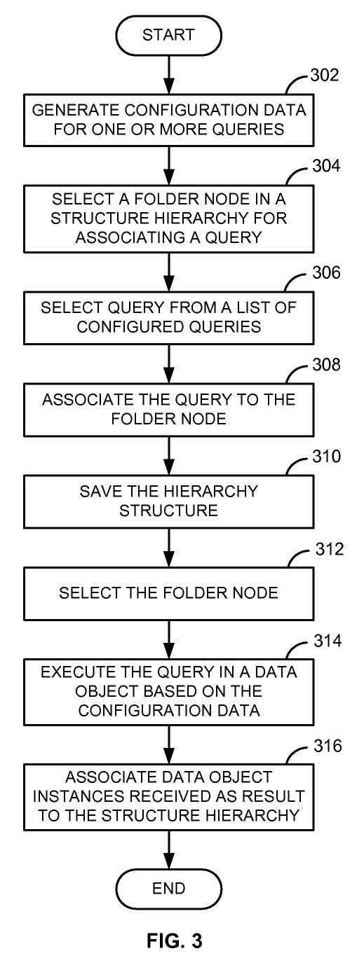

FIG. 3 is a flow diagram of a process for generating dynamic associations to data objects according to an embodiment of the invention. In process block 302, a configuration data for one or more queries is generated. In process block 304, a folder node is selected in a structure hierarchy for associating a query to the folder node. The structure hierarchy typically includes one or more folder nodes arranged in a hierarchical order. A folder node in the structure hierarchy may point to (or linked to) one or more data object instances, documents or a query. In an embodiment a folder node in the structure hierarchy may include one or more business properties. The configuration data typically includes a query definition of a query. The query definition typically includes definition of the query, a data object on which the query may be executed and one or more query parameters using which the query may be executed in the data object. In process block 306, a query is selected from a list of queries for which query definitions exists in configuration data. The list of queries is typically presented on selecting the folder node. In process block 308, the query selected from the list of queries is associated to the folder node. In process block 310, the hierarchy structure is saved to save the query associated to the folder node. In process block 312, the folder node associated to the query is selected. In process block 314, the query is executed on the data object based on the configuration data. In process block 316, one or more data object instances received as a result of executing the query on the data object are associated to the structure hierarchy typically as child nodes to the folder node.

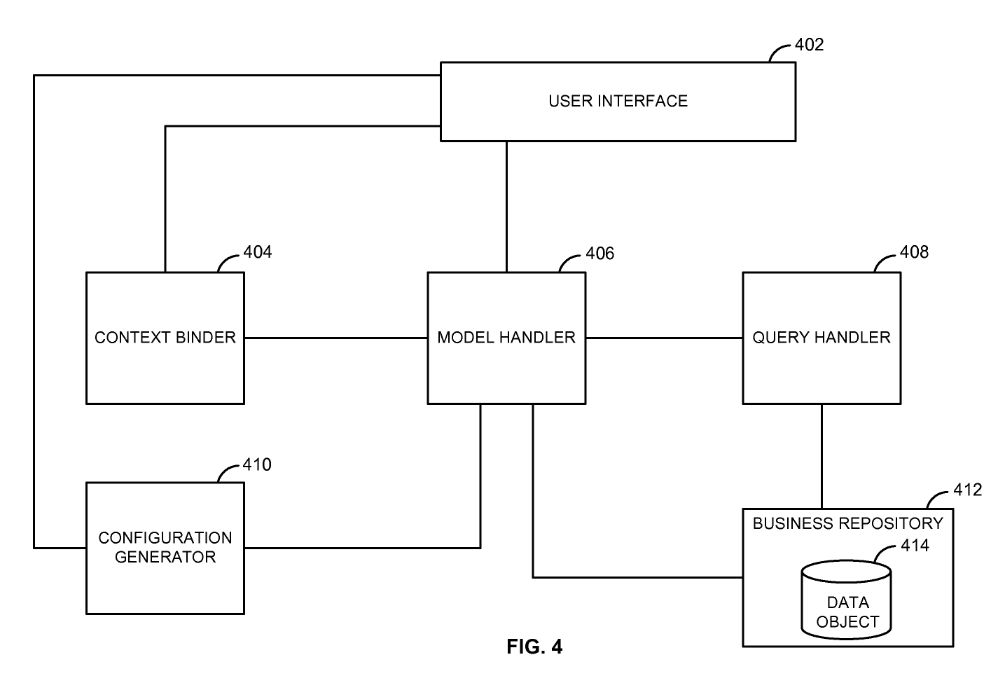

FIG. 4 is a block diagram of a system for generating dynamic associations to data objects useful for implementing the invention according to an embodiment of the invention. Model handler 406 is typically responsible for generating a structure hierarchy. The structure hierarchy typically includes one or more folder nodes arranged in a hierarchical order. A folder node in the structure hierarchy may point to (or linked to) one or more data object instances, documents or a query. Configuration generator 410 is typically responsible for generating a configuration data for the structure hierarchy. The configuration data typically includes query definitions of one or more queries that may be associated with folder nodes in the structure hierarchy. The query definition of a query associated with a folder node includes a definition of a query, a data object on which the query may be executed and one or more query parameters based on which the query may be executed on the data object. In an embodiment, a user may access configuration generator 410 through user interface 402 to generate the configuration data. Model handler 406 typically associates one or more queries for which query definitions exist in the configuration data to folder nodes in the structure hierarchy. Query handler 408, is generally responsible for executing the query associated to a folder node based on the configuration data. Query handler typically executes the query in one or more data objects 414 stored in business repository 412. Context binder 404 binds a context of user interface 402 to structure hierarchy and the query parameters used for executing the query on the business object are received from the context of user interface 402 during the runtime.

A user typically marks a folder node in the structure hierarchy for creating a query node using model handler 406. The user is generally presented with a list of queries in user interface 402 for which definitions exist in configuration data generated by configuration generator 410. The user may typically select a query from the list of queries. On selecting the query from the list of queries, the query is inserted in the folder node as a query node by model handler 406. In an embodiment, model handler 406 may be used to save the structure hierarchy to save the query node in business repository 412 along with a node position in the structure hierarchy.

On selecting the query node in user interface 402, the query definitions for the query in are read and analyzed by query handler 408. Query handler 408 determines the query, the data object and one or more query parameters to be used for searching the data object the query definitions. The query is executed in the data object based on the query definitions by query handler 408. Query handler 408 typically retrieves the query results as node identifiers. Each query result is typically a data object instance. The data object instances received as query results are associated with structure hierarchy as instance nodes to the query node by model handler 406. In an embodiment, model handler 406 associates the instance nodes as child nodes to the query node.

In an embodiment, on selecting one or more of the instance nodes in the structure hierarchy using user interface 402, an instance floor plan of the data object instance is retrieved from business repository 412 and displayed to the user in user interface 402 by model handler 406.

The particular methods associated with embodiments of the invention are described in terms of computer software and hardware with reference to flowcharts. The methods to be performed by a computing device (e.g., an application server) may constitute state machines or computer programs made up of computer-executable instructions. The computer-executable instructions may be written in a computer programming language or may be embodied in firmware logic. If written in a programming language conforming to a recognized standard, such instructions can be executed on a variety of hardware platforms and for interface to a variety of operating systems. In addition, embodiments of the invention are not described with reference to any particular programming language. It will be appreciated that a variety of programming languages may be used to implement the teachings of the invention as described herein. Furthermore, it is common in the art to speak of software, in one form or another (e.g., program, procedure, process, application, etc.), as taking an action or causing a result. Such expressions are merely a shorthand way of saying that execution of the software by a computing device causes the device to perform an action or produce a result.

Elements of the invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

What is claimed is:

1. A method comprising:
generating a structure hierarchy based on a first configuration data, the structure hierarchy having a folder node;
generating a second configuration data for a query;
associating the query to the folder node in the structure hierarchy;
executing the query in a data object based on the configuration data;
retrieving a data object instance as a result of executing the query; and
associating the data object instance with the data object.

2. The method of claim 1 further comprising saving the data object instance as a child node to the folder node.

3. The method of claim 1 wherein retrieving a data object instance comprises retrieving the data object instance as a node identifier.

4. The method of claim 1 further comprising:
selecting the data object instance from the structure hierarchy; and
retrieving an object instance floorplan of the data object instance based on a node identifier.

5. The method of claim 1, wherein the first configuration data comprises a structure template defining a position of the folder node in the structure hierarchy.

6. The method of claim 1, wherein generating a second configuration data comprises generating a second configuration data selected from a group consisting of a query identifier, a query description, a data object name, a data object node name, a data object query name and a query parameter.

7. The method of claim 1 further comprising:
selecting the data object from a list of data objects; and
linking the query with the data object.

8. The method of claim 1 further comprising:
binding the query to a context of a user interface; and
receiving a query parameter from the context as the configuration data.

9. A system comprising:
a configuration generator for generating a first and a second configuration data for a query;
a model handler electronically coupled to the configuration generator for generating a structure hierarchy based on the first configuration data, the structure hierarchy having a folder node, the model handler associating the query to the folder node in the structure hierarchy, the model handler associating a data object instance to the structure hierarchy; and
a query handler electronically coupled to the model handler for executing the query in a data object based on the configuration data and retrieving the data object instance as a result of executing the query.

10. The system of claim 9 further comprising a context binder electronically coupled to the model handler for binding the query to a context of a user interface.

11. The system of claim 9 further comprising a business repository electronically coupled to the model handler and the query handler for storing the data object instance.

12. A machine-accessible medium that provides instructions that, when executed by a machine, cause the machine to perform operations comprising:
generating a structure hierarchy based on a first configuration data, the structure hierarchy having a folder node;
generating a second configuration data for a query;
associating the query to the folder node in the structure hierarchy;
executing the query in a data object based on the configuration data;
retrieving a data object instance as a result of executing the query; and
associating the data object instance with the data object.

13. The machine-accessible medium of claim 12 further providing instructions which when executed by the machine cause the machine to perform further operations comprising saving the data object instance as a child node to the folder node.

14. The machine-accessible medium of claim 12, wherein retrieving a data object instance comprises retrieving the data object instance as a node identifier.

15. The machine-accessible medium of claim 12 further providing instructions which when executed by the machine cause the machine to perform further operations comprising:
selecting the data object instance from the structure hierarchy; and
retrieving an object instance floorplan of the data object instance based on a node identifier.

16. The machine-accessible medium of claim 12, wherein the first configuration data comprises a structure template defining a position of the folder node in the structure hierarchy.

17. The machine-accessible medium of claim 12, wherein generating a second configuration data comprises generating a second configuration data selected from a group consisting of a query identifier, a query description, a data object name, a data object node name, a data object query name and a query parameter.

18. The machine-accessible medium of claim 12 further providing instructions which when executed by the machine cause the machine to perform further operations comprising:
selecting the data object from a list of data objects; and
linking the query with the data object.

19. The machine-accessible medium of claim 12 further providing instructions which when executed by the machine cause the machine to perform further operations comprising:
binding the query to a context of a user interface; and
receiving a query parameter from the context as the configuration data.
